(19) United States
(12) Patent Application Publication
(10) Pub. No.: US 2022/0162417 A1
(43) Pub. Date: May 26, 2022

(54) A METHOD FOR RECYCLING EXPANDED POLYSTYRENE

(71) Applicant: POLYSTYRENE REFORMING PTY LTD, Red Hill (AU)

(72) Inventor: Robert Edward Fullerton, Red Hill (AU)

(73) Assignee: POLYSTYRENE REFORMING PTY LTD, Red Hill (AU)

(21) Appl. No.: 17/602,681

(22) PCT Filed: Apr. 9, 2020
(86) PCT No.: PCT/AU2020/050353

§ 371 Date: Oct. 8, 2021

(30) Foreign Application Priority Data
Apr. 11, 2019 (AU) 2019901254
Dec. 9, 2019 (AU) 2019279907

(51) Int. Cl. C08J 11/06; B29C 44/44; B29C 44/34

(52) U.S. Cl. CPC C08J 11/06; B29C 44/445; B29K 2025/06; C08J 2425/06; B29C 44/343

(57) ABSTRACT

A process for manufacturing an expanded polystyrene foam article from used expanded polystyrene foam articles in combination with virgin polystyrene foam, the process comprising the steps of: stacking a plurality of individual used expanded polystyrene foam articles in a vertical block machine to occupy at least 20% of the internal volume in the block machine; conveying virgin polystyrene beads into the internal volume of the vertical block machine to occupy at least some of the remaining internal volume of the block machine by mixing the virgin polystyrene with the used stacked foam articles; and heating the internal volume of the block machine to a temperature of at least 75° C. by supplying pressurised steam into the heated internal volume of the block machine to fuse the virgin expanded polystyrene beads and the stacked expanded polystyrene foam articles to form the expanded polystyrene foam article.

### TECHNICAL FIELD

The present invention relates to a method for recycling expanded polymers, particularly expanded thermoplastic polymers, more particularly expanded polystyrene polymers.

### BACKGROUND

Any references to methods, apparatus or documents of the prior art are not to be taken as constituting any evidence or admission that they formed, or form part of the common general knowledge.

Expanded synthetic polymeric resins are widely utilized for fabricating packaging and packing products, as well as numerous other uses such as building materials, etc. When objects and materials contained in packaging and packing products are utilized, the packaging and packing products are discarded. If these products are merely disposed in landfills, they are lost for subsequent recovery of the constituent material. Furthermore, disposal in landfills is objectionable since such products, as is typical with synthetic resins generally, are of low density and occupy inordinate volume within a landfill. Specifically, expanded polystyrene foam is highly resistant to normal biodegradation processes, potentially causing disposal problems. Because expanded polystyrene foam does not degrade, it occupies a substantial and inordinate amount of space in landfills and waste storage sites.

It is thus desirable to recover the expanded materials in a form rendering the material suitable for reuse into other products, including being reformed into additional packaging. Several recycling methods of these expanded materials have been developed.

### SUMMARY OF INVENTION

In an aspect, the invention provides a process for manufacturing an expanded polystyrene foam article from used expanded polystyrene foam articles in combination with virgin polystyrene foam, the process comprising the steps of:
heating an internal volume of a block machine to a temperature of at least 75° C.;
stacking a plurality of individual used expanded polystyrene foam articles in the vertical block machine to occupy at least 20% of the internal volume in the block machine;
conveying virgin polystyrene beads into the internal volume of the vertical block machine to occupy at least some of the remaining internal volume of the block machine by mixing the virgin polystyrene with the used stacked foam articles; and
supplying pressurised steam into the heated internal volume of the block machine to fuse the virgin expanded polystyrene beads and the stacked expanded polystyrene foam articles to form the expanded polystyrene foam article.

In an embodiment, the heating step is carried out by introducing steam into the internal volume of the block machine before stacking said plurality of used expanded polystyrene foam articles.

In an embodiment, the conveying step comprises conveying the virgin polystyrene beads in combination with a pressured gas into the internal volume of the vertical block machine.

In an embodiment, the virgin polystyrene beads in fed in combination with the pressured gas at a pressure of 0.5 Mpa for a pre-determined time period into the internal volume of the vertical block machine.

In an embodiment, the stacking step comprises positioning the individual used expanded polystyrene foam articles in a spaced relationship relative to the internal walls of the block machine defining the internal volume of the block machine.

In an embodiment, the stacking step involves positioning the expanded polystyrene foam articles upon feet members. In one embodiment, the expanded polystyrene foam is positioned in a spaced relationship relative to a base of the block machine. In an embodiment, the feet members comprises expanded polystyrene foam.

In an embodiment, the internal volume of the block machine is defined by a base with a plurality of side walls, a front wall, a back wall and a top wall. In an embodiment, the stacking step comprises positioning the stacked expanded polystyrene foam articles to be spaced away from any one or more of the side walls and top walls by at least 100 mm and more preferably at least 150 mm. In one embodiment, the stacking step comprises positioning the stacked expanded polystyrene foam articles to be spaced away from the front and rear wall by at least 30 mm.

In an embodiment, the stacking step comprises positioning the stacked expanded polystyrene foam articles to be spaced away from any one or more of the side walls by at least 100 mm and more preferably at least 150 mm and to be spaced away from front and the rear wall by at least 30 mm.

In an embodiment, the stacking step comprises stacking the plurality of individual used expanded polystyrene foam articles in a vertical block machine to occupy 30% to 40% of the internal volume in the block machine.

In an embodiment, the internal volume of the block machine is heated to a temperature in the range of 70° C. to 90° C.

In an embodiment, the internal volume of the block machine is heated to a temperature in the range of 75° C. to 80° C. and more preferably in the range of 79° C. to 81° C.

In an embodiment, the pressurised steam is supplied into the heated internal volume of the block machine at a pressure of at least 0.5 Mpa for a predetermined time period.

In an embodiment, the pressurised steam is supplied from a steam accumulator into the internal volume of the block machine in an initial steaming step at a pressure of at least 0.6 MPa for an initial time period in the range of 10s to 40s and more preferably 20s to 30s and still more preferably 24s.

In an embodiment, the pressurising step further comprises a subsequent pressurising step in which steam is supplied at a pressure of at least 0.3 MPa for a subsequent time period of 5s to 20s and more preferably for a time period of 10s.

In an embodiment, the process further comprises a cooling step whereby upon supplying steam into the internal volume, the internal volume of the block machine is cooled, preferably air cooled to a cooling temperature in the range of 70° C. to 90° C. and preferably 75° C. to 80° C. and more preferably in the range of 79° C. to 81° C.

In one embodiment, the method does not require a step of dissolving the expanded polystyrene foam articles in a solvent.

In certain embodiments, the method does not require a step of diminution of the expanded polystyrene foam articles.

In some embodiments, the method does not require the addition of chemical additives.

In one form, the invention resides in an expanded polystyrene foam article produced by the process of the above aspect.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows discarded expanded polystyrene (EPS) articles 12.

FIG. 2 illustrates a block machine 20 for use with the process in accordance with an embodiment of the present invention.

FIGS. 3A to 3H shows various step for the process in accordance with an embodiment of the present invention.

### DETAILED DESCRIPTION OF PREFERRED EMBODIMENTS

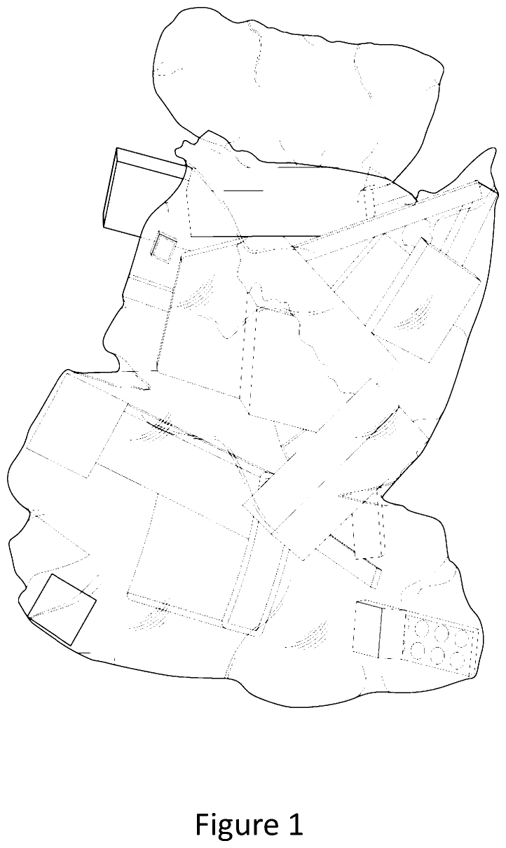

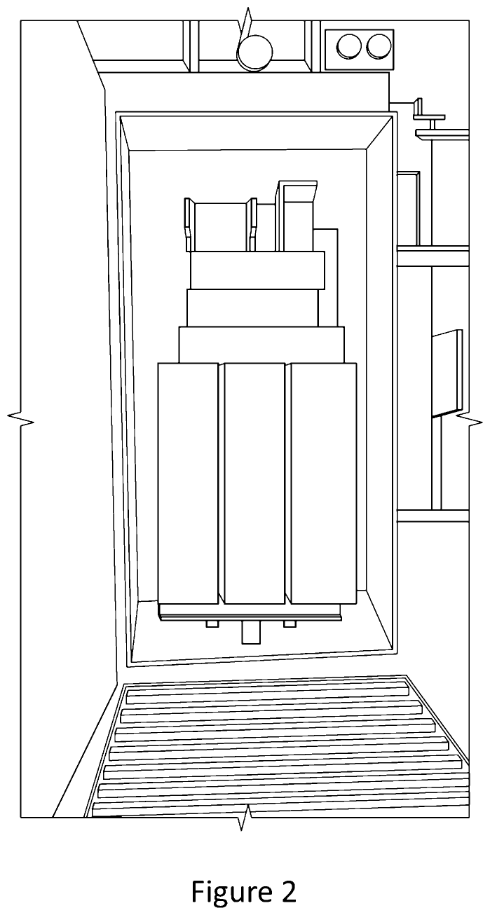

The present invention involves a unique and highly efficient method for recycling used expanded polystyrene foam materials. Specifically, the invention enables used expanded polystyrene foam (as shown in FIG. 1) to be combined with virgin expanded polystyrene materials in a novel manner to produce an expanded polystyrene foam article of substantial strength and structural integrity that can be used for a variety of purposes.

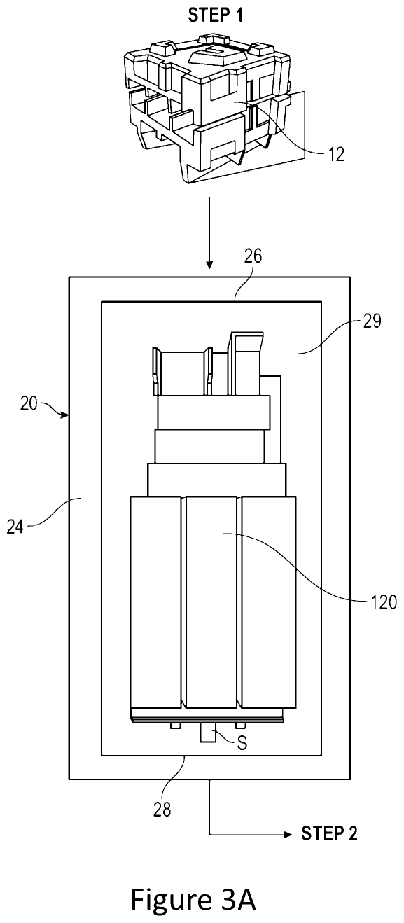

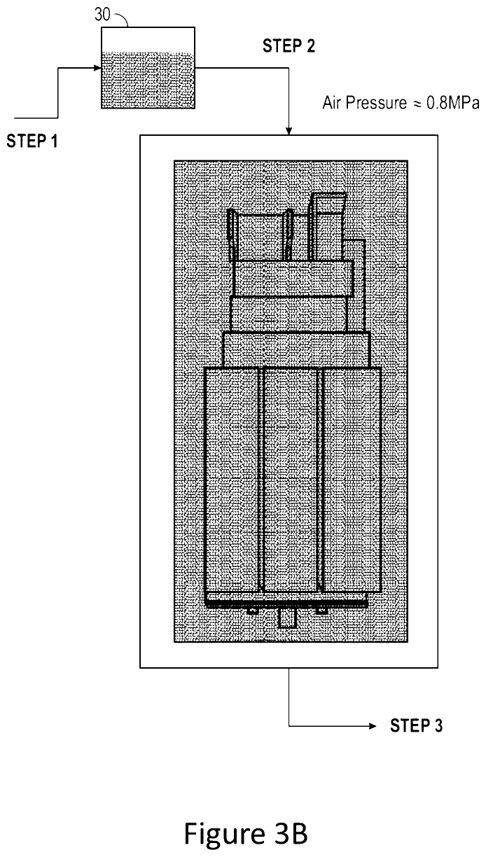

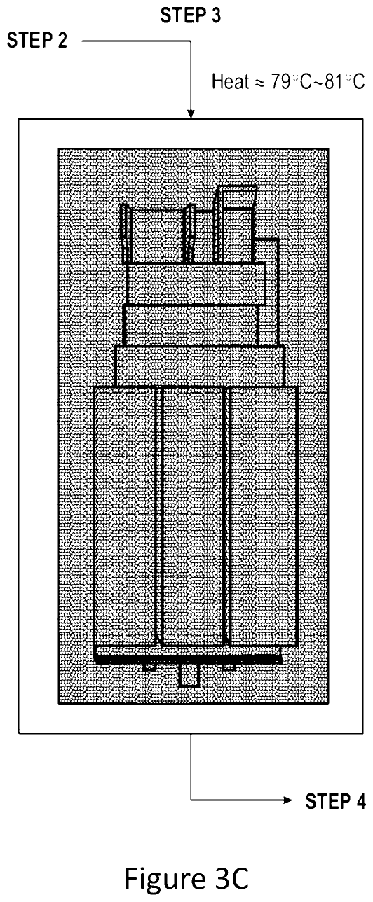

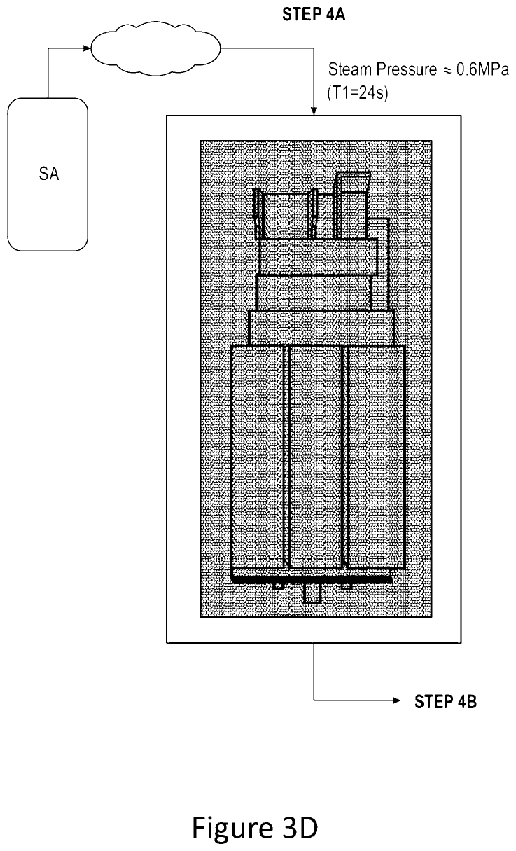

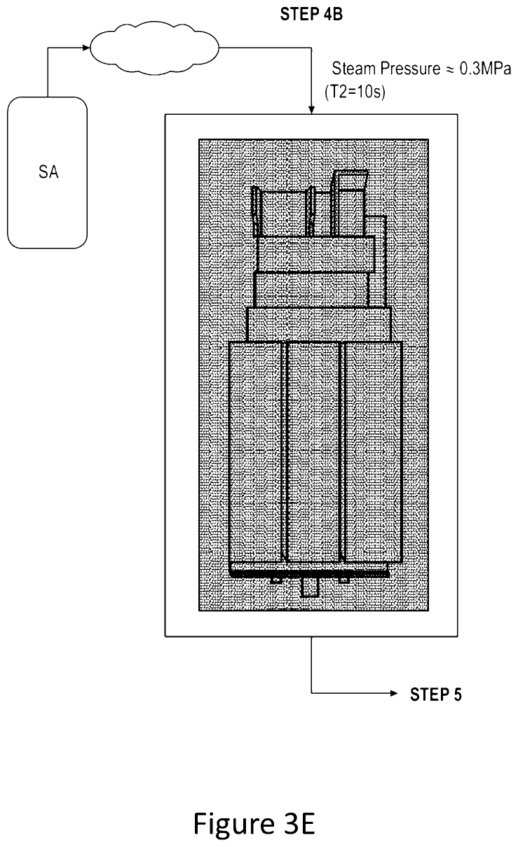

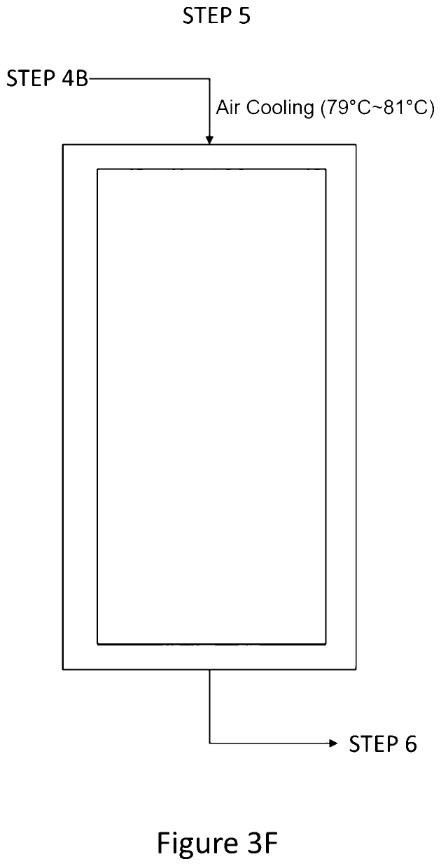

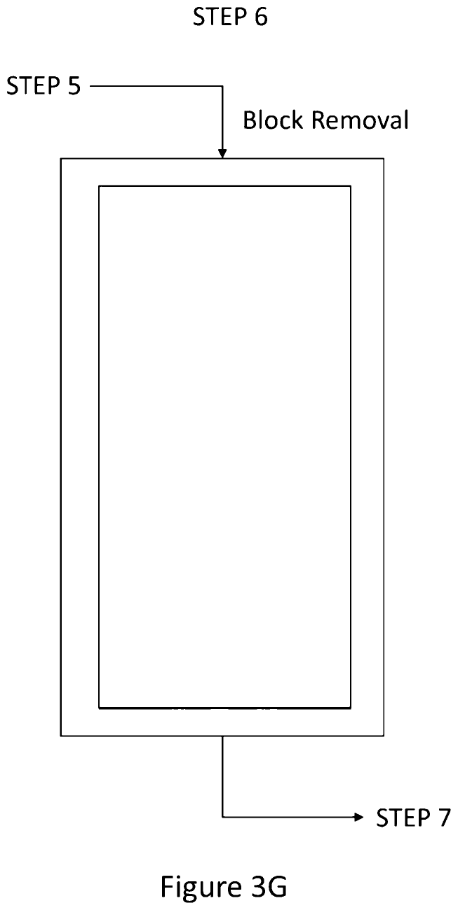

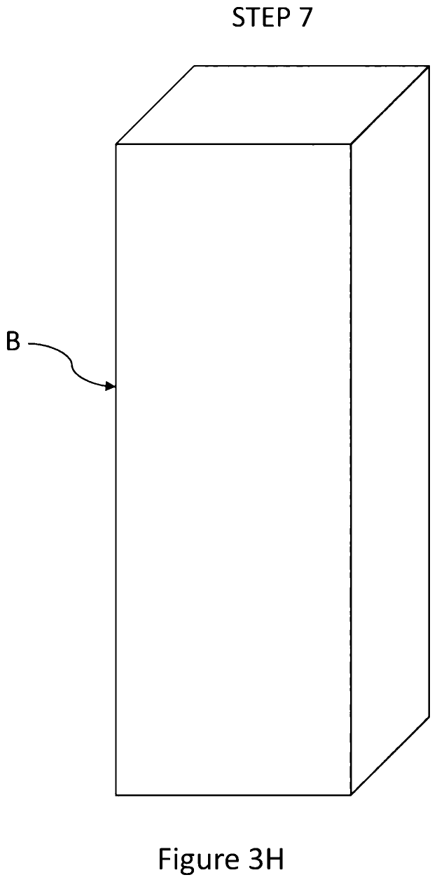

The process in accordance with an embodiment of the invention has been schematically illustrated in FIGS. 3A to 3E. In order to implement an embodiment of the invention, a vertical block EPS moulding machine 20 manufactured by NKL was customized by the inventor to implement an embodiment of the present invention. The block machine comprises a base 28, left and right side walls 24 and 22 a top wall 26 with a an upright back wall which defines an internal volume for the block machine. As with most block machines a frontal door may be provided such that in a closed position, the door may form a frontal wall thereby allowing the internal volume to be fully enclosed in an operating configuration. A supply of used expanded polystyrene foam 12 is obtained. The used expanded polystyrene (EPS) foam 12 may come from a variety of sources, including but not limited to packaging materials, used building materials, and other comparable expanded polystyrene foam articles. It is important to note that one of the many non-limiting advantages of the presently described process is that the process does not require the used EPS articles 12 to be crushed or grounded as will be apparent from the explanation provided in the foregoing sections. Three feet members S made from EPS are positioned on the base 28 of the block machine to provide spacing between the used expanded polystyrene foam and the base 28 of the block machine.

An initial pre-heating step, the internal volume of the block moulding machine 20 is heated by introducing steam into the internal volume of the block moulding machine 20. The introduction of the steam into the internal volume of the vertical block moulding machine 20 is useful for raising the temperature of the internal volume from an initial temperature to a relatively higher temperature. In at least one exemplary embodiment, it has been found that introduction of steam may raise the temperature up to 80 degrees and in some instances over 85 degrees. A digital temperature gauge may be used to monitor the internal temperature to try and ensure that an initial temperature of at least 75° C. is achieved. During practical implementation of the pre-heating step it may be necessary to stop the heating step once a slightly higher temperature of say 86° C. has been achieved. In practical operating environments, it can be expected that as soon as the steaming step is paused and the block machine door is opened, there would a gradual drop in temperature to a temperature range of 75° C. to 85° C. and more preferably 79° C. to 81° C. before the initial step of stacking used expanded polystyrene articles within the internal volume is carried out. It is important to appreciate that the initial pre-heating step does not necessarily need to be carried out by supplying steam into the internal volume and it is envisioned by the inventor that other conventional heating methods for heating the internal volume of the block machine 20 to a sufficiently high temperature may be used.

The initial step, step 1, involves stacking a plurality of used expanded polystyrene articles to be stacked on top of each other. Providing some spacing between the stacked EPS used articles 120 and the base 28 to allow virgin expanded polystyrene beads and steam to flow freely through the spacing. In the preferred method, the stacked expanded polystyrene articles 120 are also positioned to ensure that the stack 120 is spaced away from the side walls 22 and 24 by at least 150 mm and spaced away from the back wall 29 by at least 30 mm.

The second step, step 2, involves conveying virgin expanded polystyrene beads 30 into the internal volume of the vertical block machine 20 to occupy at least the remaining internal volume of the block machine 20. It is important to note that gravity feeding the virgin expanded polystyrene beads is not suitable and the inventor has found that mixing the virgin EPS beads with air at an air pressure of 0.8 MPa forces the beads into small cavities and crevices within the internal volume of the block machine 20 that are formed due to placement of non-regular and non-uniform sized used expanded polystyrene articles within the internal volume.

Once the virgin EPS beads 30 have been supplied into the internal volume of the block machine 20, the next step, step 3 is an optional step, involves heating the contents and the internal volume of the block machine 20 to a higher temperature by supplying steam into the internal volume of the block machine 20 to raise the temperature to temperature that is at least 75° C. and more preferably in the range of 75° C. to 85° C. and more preferably in the range of 79° C. and 81° C. In the preferred embodiment, a digital gauge was installed in the block machine 20 for monitoring the temperature within the internal volume of the block machine 20. This optional step may be necessary if the previously mentioned pre-heating step has not been carried out to achieve a raised temperature before stacking the used expanded polystyrene foam articles.

The heating step, step 3, may be followed by a two stage steaming step 4 comprising sub-steps 4A and 4B. The first steaming sub-step 4A involves supplying steam into the internal volume of the block machine 20 at a higher pressure of 0.6 MPa (at a temperature of approximately 166° C.) from a steam accumulator SA for an initial steaming time period of 24 seconds. The initial steaming sub-step 4A is followed by the second sub-step 4B which involves supplying steam into the internal volume of the block machine 20 at a pressure of 0.3 MPa (at a temperature of approximately 130° C.) from the steam accumulator SA for a subsequent steaming time period of 10 seconds. It has been found by the inventor that the steaming process in combination with the other preceding steps including the heating step allows fusion of the virgin EPS beads 30 with the stacked used EPS articles 120 to allow a single moulded article to be formed within the internal volume of the block machine 20.

The steaming step 4 is followed by a cooling step, step 5, which involves air cooling the internal volume of the block machine to a temperature in the range of 79° C. to 81° C. The air cooling step may be carried out by supplying cooling air into the internal volume of the block machine 20 for a time period of 118 seconds.

Once the internal volume of the block machine 20 has been cooled, the final step, step 6, involves removing the fused block B out of the block machine 20 by using conventional removal means.

The process in accordance with an embodiment of the present invention allows discarded EPS articles to be fused with virgin EPS beads to form a moulded EPS particles without requiring the discarded EPS articles to be ground or broken into smaller pieces (commonly known as volume reduction) or being dissolved in solvents and conducting complex separating procedures before conducting any recycling procedures. The aforementioned method also alleviates the need for adding any chemical additives into the block moulding machine. Therefore, the process as described herein makes recycling of used EPS articles to be used more easily without expending excessive quantities of energy for recycling.

In one embodiment, the method does not require a step of dissolving the expanded polystyrene foam articles in a solvent. In certain embodiments, the method does not require a step of diminution of the expanded polystyrene foam articles. In some embodiments, the method does not require the addition of chemical additives. A non-limiting example of such chemical additives that may be typically required in prior art recycling methods is pentane. Similarly, prior art methods require the use of organic solvents such as dimethyl carbonate which can be highly toxic and difficult to handle.

With respect to expanded polystyrene foam, a number of previous methods had been attempted in order to recycle/recover used and expanded polystyrene foam. For example, waste foam materials had been ground and combined with virgin foam beads, with the waste foam materials merely functioning as “filler”. However such method were found to be relatively ineffective. The method as described herein overcomes limitations of the prior art methods by retaining the physical properties of the used and expanded polystyrene foam articles whilst at the same time achieving expanded polystyrene from virgin beads that have undergone fusion with the older used and expanded polystyrene articles under very specific fusion conditions as surprisingly discovered by the inventor.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

What is claimed:

1. A process for manufacturing an expanded polystyrene foam article from used expanded polystyrene foam articles in combination with virgin polystyrene foam, the process comprising the steps of:
stacking a plurality of individual used expanded polystyrene foam articles in the vertical block machine to occupy at least 20% of the internal volume in the block machine;
conveying virgin polystyrene beads into the internal volume of the vertical block machine to occupy at least some of the remaining internal volume of the block machine by mixing the virgin polystyrene with the used stacked foam articles;
heating the internal volume of the block machine to a temperature of at least 75° C. and
supplying pressurised steam into the heated internal volume of the block machine to fuse the virgin expanded polystyrene beads and the stacked expanded polystyrene foam articles to form the expanded polystyrene foam article.

2. A process in accordance with claim 1 wherein the-heating step is carried out by introducing heat into the internal volume of the block machine before stacking said plurality of used expanded polystyrene foam articles to raise the temperature of the internal volume to at least 75° C. and more preferably to a pre-heating temperature in the range of 80° C. to 90° C.

3. A process in accordance with claim 1 wherein the conveying step comprises conveying the virgin polystyrene beads in combination with a pressured gas into the internal volume of the vertical block machine.

4. A process in accordance with claim 3 wherein the virgin polystyrene beads in fed in combination with the pressured gas at a pressure of 0.5 Mpa for a pre-determined time period into the internal volume of the vertical block machine.

5. A process in accordance with claim 1 wherein the stacking step comprises positioning the individual used expanded polystyrene foam articles in a spaced relationship relative to the internal walls of the block machine defining the internal volume of the block machine.

6. A process in accordance with claim 1 wherein the stacking step involves positioning the expanded polystyrene foam articles upon feet members in order to position the expanded polystyrene foam articles in a spaced relationship relative to a base of the block machine and wherein the feet members comprises expanded polystyrene foam.

7. A process in accordance with claim 1 wherein the internal volume of the block machine is defined by a base with a plurality of side walls, a front wall, a back wall and a top wall and wherein the stacking step comprises positioning the stacked expanded polystyrene foam articles to be spaced away from any one or more of the side walls and top walls by at least 100 mm and more preferably at least 150 mm.

8. A process in accordance with claim 7 wherein the stacking step comprises positioning the stacked expanded polystyrene foam articles to be spaced away from any one or more of the side walls by at least 100 mm and more preferably at least 150 mm and to be spaced away from front and the rear wall by at least 30 mm.

9. A process in accordance with claim 1 wherein the stacking step comprises stacking the plurality of individual used expanded polystyrene foam articles in a vertical block machine to occupy 30% to 40% of the internal volume in the block machine.

10. A process in accordance with claim 1 wherein the internal volume of the block machine is heated to a temperature in the range of 75° C. to 90° C.

11. A process in accordance with claim 10 wherein the internal volume of the block machine is heated to a temperature in the range of 75° C. to 85° C. and more preferably in the range of 79° C. to 81° C.

12. A process in accordance with any one of the preceding claims wherein the pressurised steam is supplied into the heated internal volume of the block machine at a pressure of at least 0.5 Mpa for a predetermined time period.

13. A process in accordance with claim 12 wherein the pressurised steam is supplied from a steam accumulator into the internal volume of the block machine in an initial pressurised steaming step at a pressure of at least 0.6 MPa for an initial time period in the range of 10s to 40s and more preferably 20s to 30s and still more preferably 24s.

14. A process in accordance with claim 12 wherein the pressurising step further comprises a subsequent pressurised steaming step in which steam is supplied at a pressure of at least 0.3 MPa for a subsequent time period of 5s to 20s and more preferably for a time period of 10s.

15. A process in accordance with claim 1 further comprising a cooling step whereby upon supplying steam into the internal volume, the internal volume of the block machine is cooled, preferably air cooled to a cooling temperature in the range of 70° C. to 90° C. and preferably 75° C. to 80° C. and more preferably in the range of 79° C. to 81° C.

16. (canceled)
